(19) United States
(12) Patent Application Publication
(10) Pub. No.: US 2017/0270326 A1
(43) Pub. Date: Sep. 21, 2017

(54) BAND/TAG WITH INTEGRATED STATUS AND TRACKING

(71) Applicant: Iconex LLC, Duluth, GA (US)

(72) Inventors: Austin Daniel Anderson, Dacula, GA (US); Jeffrey Alton Whitford, Richmond, KY (US)

(21) Appl. No.: 15/074,440

(22) Filed: Mar. 18, 2016

(51) Int. Cl. G06K 7/10; G06K 19/077

(52) U.S. Cl. CPC G06K 7/10366; G06K 19/07745

(57) ABSTRACT

A tag/band and techniques of using a tag/band are provided. The tag/band providing a visual indication of a status relevant to an item to which the tag/band is associated. In an embodiment, the tag/band also providing a mechanism for tracking the item to which the tag/band is associated.

### BACKGROUND

Food products have limited durations of time in which the food products must be consumed because either the products are no longer safe for human consumption or the products lack freshness qualities that can be distasteful to consumers by adversely affecting the taste of the food products.

Restaurants have entire systems in place to deal with handling food products that can be safely reused while maintaining the food products' freshness qualities. Reusable food products/ingredients are often placed in containers and refrigerated for subsequent reuse. However, strict procedures and techniques are implemented to ensure mistakes are not made or at least minimized.

Fast food restaurants and hotel food services are even more highly disciplined in their procedures and techniques for preserving and tracking reusable food products/ingredients. Some enterprises use pre-printed labels that are peeled off a liner, some of the labels have predetermined dates from a calendar printed or handwritten thereon. Typically, bulk food is prepped and then put into smaller containers for storage and the containers are affixed with the labels. The smaller containers are used for a set amount of time and when that time expires the food in the smaller containers is thrown away. However, mistakes are made and sometimes when food in these smaller containers need to be thrown away they are not.

The entire procedures and techniques employed are highly manual and fraught with errors/mistakes. Moreover, the labels can turn black and be difficult/impossible to read when the container to which they are affixed is heated. Refrigeration of the container and heating of the container may also cause the label to fall into the food of the container of fall off the container altogether. The label printed material and the label adhesive (for affixing to a container) fail in extreme hot and cold conditions to which the containers are subjected to often.

### SUMMARY

In various embodiments, a band/tag with integrated status and tracking capabilities, a method for managing and tracking a band/tag with integrated status and tracking capabilities, and a system for managing and tracking a band/tag with integrated status and tracking capabilities are presented.

According to an embodiment, a band/tag is presented. Specifically, and in an embodiment, a tag includes: a hardware-processor, a controller, and affixing mechanism. The controller configured to i) execute on the hardware processor, ii) wirelessly receive instructions for selectively activating illumination of one of a plurality of colored lights, and iii) illuminating a different one of the plurality of colored lights during processing of the instructions. The affixing mechanism configured to affix the physical tag to an item.

### BRIEF DESCRIPTION OF THE DRAWINGS

FIG. 1A is a diagram of bands, according to an example embodiment.

FIG. 1B is a diagram bands with timer clocks, according to an example embodiment.

FIG. 1C is a diagram of a band affixed to a sample food container, according to an example embodiment.

FIG. 1D is a diagram of a band with a timer clock affixed to a sample food container.

FIG. 1E is a diagram of a tag with integrated status and tracking capabilities, according to an example embodiment.

FIG. 1F is a rear side vide of the tag presented in the FIG. 1E, according to an example embodiment.

FIG. 2 is a diagram of a system for managing and tracking a band/tag with integrated status and tracking capabilities, according to an example embodiment.

FIG. 3 is a diagram of a method for managing and tracking a band/tag with integrated status and tracking capabilities.

### DETAILED DESCRIPTION

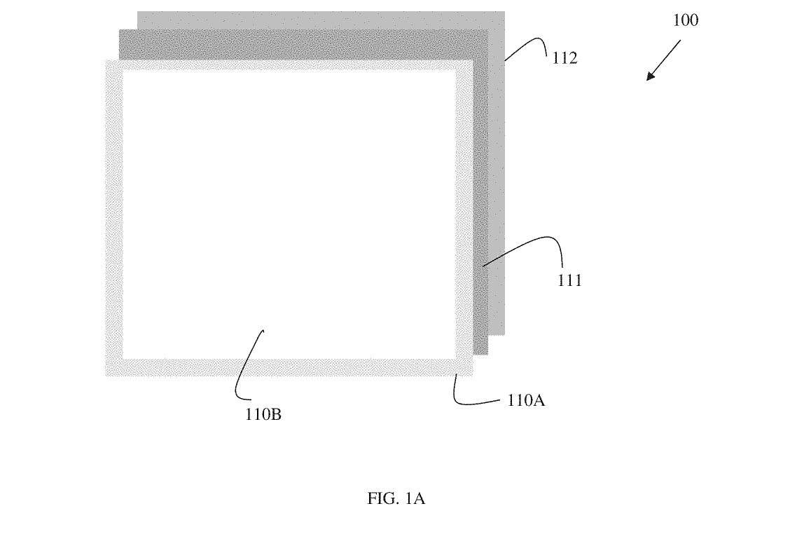

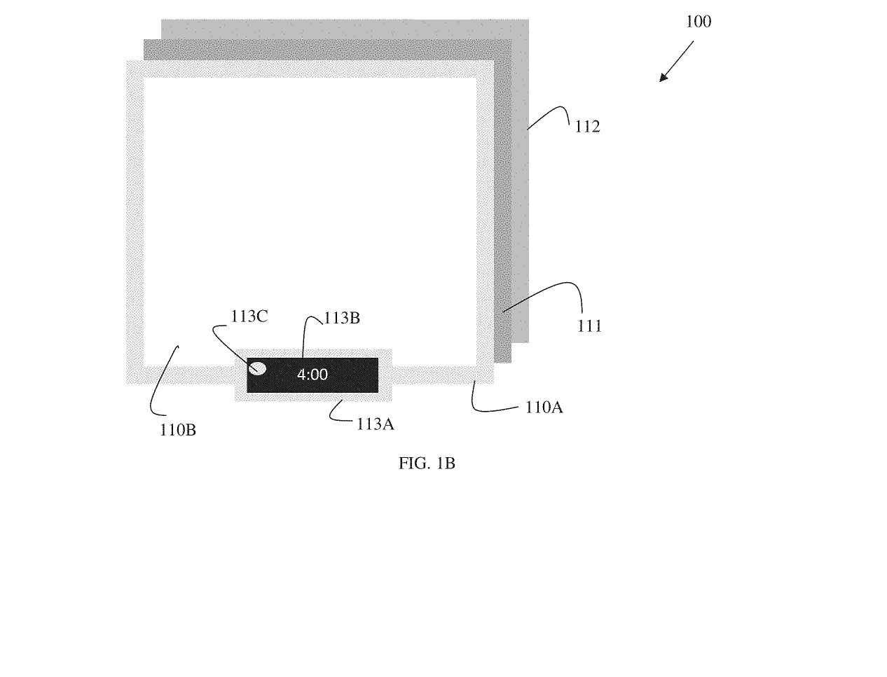

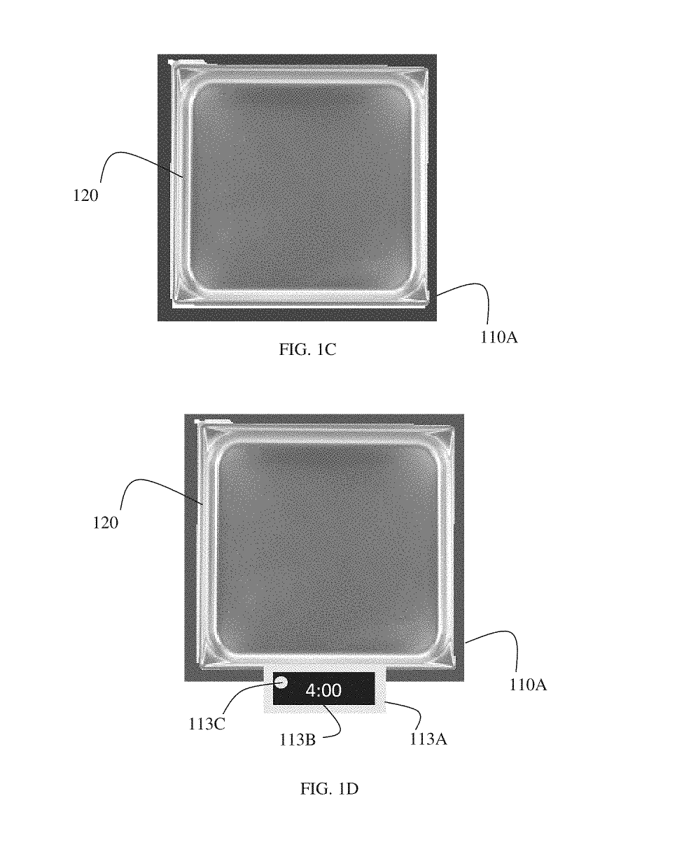

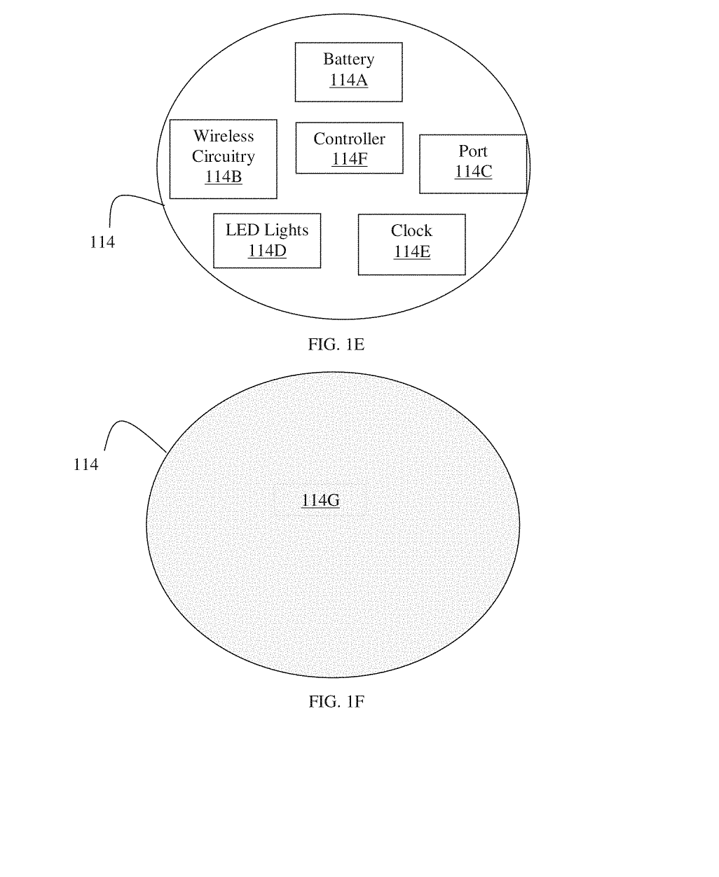

FIG. 1A is a diagram 100 of bands, according to an example embodiment. In the example embodiment, four bands are shown 110A, 111, and 112 each represented by a different shading of grey, each shading of grey representing a specific color, such as but not limited to red, green, yellow, and others.

The colors of each band (110A, 111, and 112) represent a different status that is to be associated with containers of food to which the bands (110A, 111, and 112) are affixed. For example, a red band may indicate use before 10 am, a green band may indicate use before 5 pm, etc. In fact, the colors of the bands (110A, 111, and 112) can be determined by a food enterprise based on that enterprise's procedures for handling and identifying the freshness of food products placed in containers to which the bands (110A, 111, and 112) are affixed, removed, and reused. That is, the bands (110A, 111, and 112) are completely reusable and do not have to be thrown away and can be used with other containers within the enterprise. Today, with labels reuse of the labels is not feasible.

Each band (110A, 111, and 112) includes four sides and void area 110B. The void area 110B can be enlarged to be large enough to fit over a lip of the top opening of a container and stretchable adjust to snuggly affix around the periphery of the top of the container (the opening in the container from which food is accessed). That is, each band (110A, 111, and 112) is slightly smaller than a top opening of a container that the band (110A, 111, or 112) is designed to be affixed to and the band (110A, 111, or 112 is made of elastic material to stretch to a size slightly larger the container opening and any lip around the opening of the container. Once stretched, the band (110A, 111, or 112) attempts to contract back to its original size but is restricted because of the sides of the container to which it is being affixed. This ensures that the band (110A, 111, and 112) does not fall or slip off the container. Conventionally, with container labeling, the container labels often fell of the containers; sometimes into the food of the containers, and sometimes onto the floor and surfaces of an enterprise creating litter and waste that needs periodically cleaned up.

An example affixed band 110A is shown around a sample container 120 in the FIGS. 1C and 1D below.

Each band (110A, 111, and/or 112) is manufactured of materials that are resistant to extremes heat and cold and that has elastic qualities as discussed above. For example, the bands (110A, 111, and 112) are made of silicon and/or rubber based materials. The bands (110A, 111, and 112) are also made of a material that permits them to be washed and cleaned when necessary to do so.

In an embodiment, the bands (110A, 111, and 112) are picture shaped in a rectangular form having the void 110B and designed to stretch and snuggly fit around stainless steel containers or cooking pans. A particular color of any particular band (110A, 111 or 112) would provide an immediate and instant visual cue to a food worker as to what time of day the food in the container or pan to which the ban (110A, 111, or 112) is affixed to is good for (such as from 7:30 am to 10:30 am). The band (110A, 111, or 112) can be stored in heated cabinets or refrigerated cabinets (refrigerators).

It is to be noted that the dimensions of the bands (110A, 111, and 112) can be configured and manufactured to stretch, retract, and affix to any desired container, and the color for any band (110A, 111, and 112) manufactured based on any particular enterprise's food handling procedures.

The bands (110A, 111, and 112) are completely reusable and can result in substantial savings over the conventional label-based throw away approaches. The bands (110A, 111, and 112) also improve manual procedures with no need for custom printed labels or handwritten labels.

FIG. 1B is a diagram bands with timer clocks, according to an example embodiment.

In this embodiment, each of the bands (110A, 111, and 112) still include a variety of different customized colors but also include a timer clock 113A, displaying a time 113B, and perhaps a tiny time set-reset button 113C (for resetting the time). For example, the set-reset button 113C can be repeated pressed to add time (hours and/or minutes) once the set-reset button 113C detects no additional presses within a few seconds the time set as depicted on the display 113B begins to count down to zero. Based on the color of the band 110A when the display 113B is zero, a food worker will know to either change the band 110A to a new color band (such as one of bands 111 or 112) or to throw the food inside the container to which the band 110A is affixed away.

In an embodiment, the timer clock 113A may also include an tiny alarm to make a repeated audible sound to alert a nearby food worker when the worker walks by or when the worker opens a heated or refrigerator cabinet having the container with the affixed band 110A that the timer clock 113A display has counted down to zero and action is needed by the worker with respect to either the band 110A or the food inside the container.

In an embodiment, the timer clock 113A is manufactured with the band 110A as one single integrated manufactured band 110A.

In an embodiment, the timer clock is a separate manufactured timer-clock 113A that can be affixed and removed to the band 110A or to bands 111 and 112.

In an embodiment, the bands 110A. 111, and 112 include manufactured mechanisms to affix, lock, and remove an independent time-clock 113A.

In an embodiment, the timer clock 113A includes a manufactured mechanism to affix, lock, and remove the timer clock 113 from the bands 110A, 111 and 112.

In an embodiment, the timer clock 113A includes on a rear side (the side affixed to a band (110A, 111, or 112) a reusable adhesive coating to be repeatedly affixed and removed from the bands (110A, 111, and 112). In an embodiment, the reusable adhesive can be reapplied to the rear side of the time clock 113A when the adhesion of the adhesive material begins to lose adhesion qualities.

FIG. 1C is a diagram of a band affixed to a sample food container, according to an example embodiment.

The FIG. 1C illustrates that band 110A stretches to fit snuggly and securely around the periphery and lip of a pan; container 120. Again, the band 110A is of a predefined color having a meaning within a food service enterprise as to the freshness of the food placed in the pan/container 120 to that enterprise in its food handling procedures.

FIG. 1D is a diagram of a band with a timer clock affixed to a sample food container.

In this embodiment, the band 110A includes a time-clock 113A having a display for display a countdown time 113B, and a set-reset button 113C. This was discussed above with reference to the FIG. 1B. It should also be noted that the time counter can be reset to zero with a single continuous press and hold on the set-reset button 113C.

FIG. 1E is a diagram of a tag with integrated status and tracking capabilities, according to an example embodiment.

The FIG. 1E shows the inside components of an intelligent tag 114, according to an embodiment presented herein. Unlike the previous embodiments, the tag 114 can change a color based on programmed settings, therefore the manufactured color of tag 114 is managed through programmed control.

The tag 114 is an independent, mobile, physical processor and processing-enabled device.

The tag 114 includes a battery (power source) 114A, wireless circuitry 114B, a port 114C, LED light sources 114D, an optional clock 114E, and a controller 114F. It is noted that the tag 114 also includes a processor, memory, and optional storage. The physical dimension of the tag 114 can be configured and can be small, such as the size of a penny or less.

In an embodiment, the port 114C permits the battery 114A to be recharged.

In an embodiment, the battery 114A is replaced when it runs out of charge.

The port 114C provides a wired connection for interfacing and communicating with the controller 114F.

The wireless circuitry 114B includes a wireless transceiver for sending information from the controller 114F over a wireless network to a networked device and for receiving information at the controller 114F from the networked device over the wireless network.

In an embodiment, the wireless network is WiFi, Bluetooth™, or Low Energy (LE) Bluetooth™.

The controller 114F is capable of receiving and executing programmed instructions through the wireless circuitry 113B and/or the port 114C. The controller 114F also retains a unique identifier for the tag 114 which is provided during network communication to the networked device. Additionally, the controller 114F includes an interface for interacting with the networked device during execution of the programed instructions on the tag 114.

Optionally, a clock 114E is included with the tag and is controlled by the programmed instructions processed by the controller 114F. The interface of the controller 114F permits the controller 114F to receive external instructions to set and rest the clock 114E. In an embodiment, the clock 114E also presents a countdown timer display in the manner discussed above in the FIGS. 1B and 1D.

The controller 114F may also use the clock 114E as a strictly internal mechanism to monitor for purposes of changing color LED lights 113D, which illuminate from the tag 114, such that a particular color of a particular LED light 113D is visible when being viewed by an observer of the tag 114.

The controller 114F can be programmed to perform a variety of operations, some of which were discussed above (identify and illuminate a particular LED light 114D (particular color) based on an initial setting and then change to a different color based on the clock 114E reaching a countdown time of zero for purposes of food service handing when the tag 114 is affixed to a food container/pan). Additionally, the controller 114F can be used for tracking status and inventory of a particular product. That is, the networked device in communication with the tag 114 may be in communication with a variety of other tags 114 affixed to other products, each tag 114 may include a tag identifier to uniquely identify that tag 114 to the exclusion of other tags 114 and each tag may be programmed to retain and report a product type to which that tag 114 is current affixed. This permits the networked device to manage inventory of product types. In addition, location information may be obtained from the tag 114 through WiFi information and signal strength reported by the wireless circuitry 113B to the controller 114F for the controller 114F to report physical location of the tag 114 to the networked device.

The tag 114 presents enhanced uses of the bands discussed in the FIGS. 1A-1D, such that no physical changing of bands is necessary for food service embodiments and such that the tag 114 can be substantially smaller in size. Moreover, the tag 114 can be affixed to specific rows within heated or refrigerated cabinets; rather than to specific containers or pans; although the tag 114 can still be affixed to a container or pan, in which case the other materials of the tag 114 are sufficient to withstand extreme heat and cold. In some cases, the tag 114 is affixed to the outside of the heated cabinets or refrigerated cabinets.

The tag 114 also has application beyond food service as mentioned above and can be used for any product tracking, status, location, and inventory manager of a product through network interaction between the tag 114 and the networked device (as discussed above).

FIG. 1F is a rear side vide of the tag presented in the FIG. 1E, according to an example embodiment. The rear side of the tag 114 includes a reusable adhesive coating 114G for adhering or affixing the tag 114 to a product, container, cabinet, and/or pan (as used herein, an “item” is packaging of a product, a product, a physical structure, a container, a pan, and a cabinet; the tag 114 can be affixed to any item). The reusable adhesive coating 114G permits the tag 114 to be removed from one item and adhered or affixed to another entirely different item. Moreover, when the adhesive coating 114G loses its adhesive qualities, the rear side of the tag can be recoated with the adhesive coating 114G or dipped into adhesive coating 114G for recoating the adhesive coating 114G on a rear side of the tag.

In an embodiment, the tag 114 is adhered to or affixed to any of the bands 110A, 111, and 112 in place of the timer clock 113B or in addition to the timer clock 113B. So, in an embodiment, the tag 114 can be used to track and inventory the bands 110A, 111, and 112 when affixed to those bands 110A, 111, and 112. In another case, the tag, 114 is affixed to a color neutral band and used to provide color indications for food service handling through the programmed controller 114F selectively activating different colored LED lights 113D.

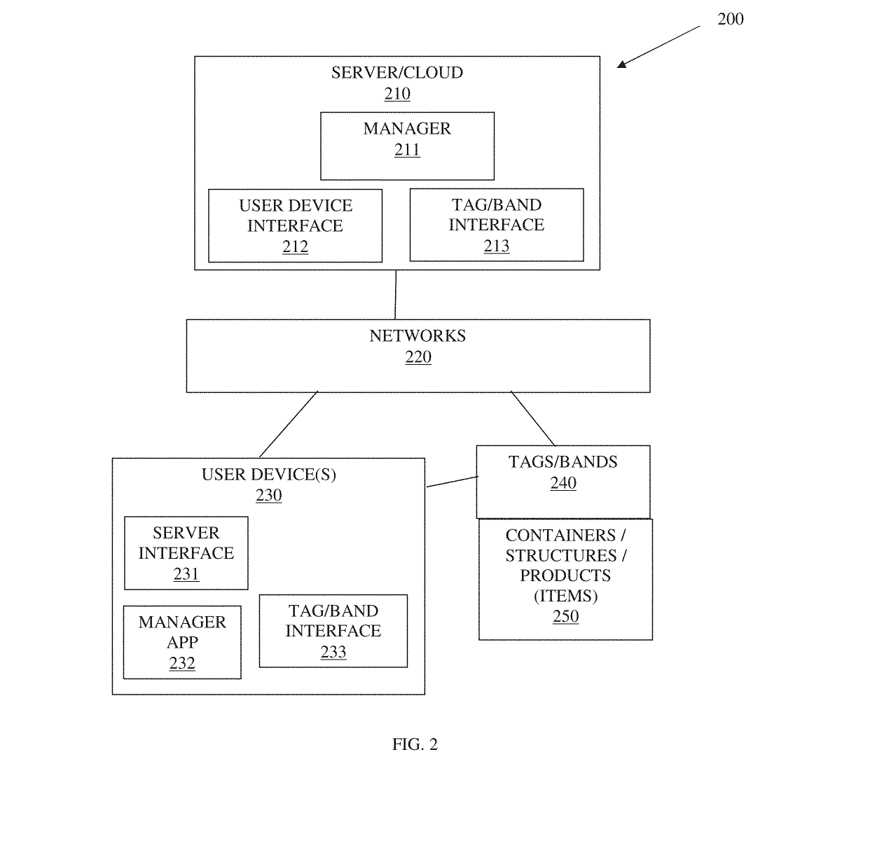

FIG. 2 is a diagram of a system 200 for managing and tracking a band/tag with integrated status and tracking capabilities, according to an example embodiment.

The system 200 includes a server/cloud 210, one or more device communication networks 220, one or more user devices 230, and a plurality of tags/bands 240.

The server/cloud 210 includes a manager 211, a user device interface 212, and a tag/band interface 213. Each of 211, 212, and 213 are programmed as non-transitory computer-readable storage media executable instructions and executed by one or more processors of the server/cloud 210.

In an embodiment, the server/cloud 210 is the networked device discussed above with the discussion of the FIG. 1E.

The networks 220 can include one or more types of networks, such as wireless, wired, WiFi, Ethernet, Bluetooth™, LE Bluetooth™, and cellular.

The user devices 230 can include laptops, desktop computers, and mobile devices including phones, tablets, and wearable processing devices. A user device 230 includes a server interface 231 and optionally a manager application (app) 232 and a tag/band interface 233. When the user device 230 includes the manager app 232 and the tag/band interface 233, the user device 230 can be the networked device discussed above in the FIG. 1E. Each of 231, 232, and 233 are programmed as non-transitory computer-readable storage media executable instructions and executed by one or more processors of the user device 230.

The tags/bands 204 are the tags discussed above with respect to the FIGS. 1A-1F. In cases, where the bands of FIGS. 1A-1D are used those bands include the tag 114 affixed thereto as discussed in the FIGS. 1E-1F. The tags are affixed to items. To track and manage those items.

In an embodiment, the server interface 231 of the user device 230 is processed to connect over a network 220 with the user device interface 212 of the server/cloud 210 for purposes of programming or obtaining tracking, status, and/or location information from the tag 240. The manager 211 receives requests from users operating the user devices 230 through the user device interface 212 and directs requests or instructions through the tag/band interface 213 for communication over a wireless network 220 with the tags 240. Communication from the tags 240 flow back through the tag/band interface 213, the manager 211, and the user device interface 212 to the server interface 231 of the user device 230.

In an embodiment, the manager app 232 issues requests or instructions to the tags 240 over a wireless network 220 to the tags 240 through the tag/band interface 233 and communication flows back to the user device 230 from the tags 240 over the network 220 to the tag/band interface 233 and the manager app 232.

So, items (having affixed tags 240) can be tracked, managed, inventoried in real time, and status obtained from the system 200 either through a server-based approach (through server/cloud 210 and user device 230) or a direct approach using a user device 230 absent the server/cloud 210.

In still another embodiment for application of the tag 240, consider a consumer having one or more tags 240. The consumer can download the manager app 232 having the tag/band interface 233 or the server interface 231 for web-based browser interaction with the server/cloud 210. The consumer can then interact directly with the tag 240 to activate and register the tag 240 with the consumer's user device 230 (such as a mobile phone), when initialized the tag 240 is programmed to emit a green LED light. The consumer may also indirectly interact with the tag 240 through the server interface 231 through browser access on the mobile device 230 with the server/cloud 210. The network 220 accessed by the mobile device 230 can be cellular or wireless. The consumer can then have a variety of user-determined uses for the tag 240, such as affixing the tag 240 to leftover food containers in the consumer's refrigerator and operate the mobile device 240 to set a timer for the tag to activate. When the time expires, the tag 240 illuminates a red LED light. Upon seeing the red light of the tag affixed to the leftover food container, the consumer knows that the time went off and the food inside the container should be thrown away. In another case, the tag 240 can be affixed by the consumer to articles of possessions of the consumer about the consumer's home, such as keys, electronics, even stacks of papers, when consumer programmed lights change it may be an indication that the consumer is to be reminded of something that the consumer wanted to be reminded of; alternative, the consumer may use the tag to locate the tag 240 within the house through location-based services available with the tag 240. The manager app 232 on the mobile device 230 can be used to guide the consumer to the whereabouts of the tag 240 for locating the desired article.

In an embodiment, the tag 240 may include an audible speaker for playing a sound or tone of varying configured degrees of decibels (loudness). Activating the sound on the tag 240 through the manager app 232 may permit locating the physical whereabouts of the tag 240 through an audible sound or tone that progressively becomes louder the longer the sound remains playing through the speaker of the tag 240.

In fact, a variety of applications of the tag 240 and the system 200 can be used and customized to the needs of individual consumers and/or enterprises, such that the tag 240 and the system 200 can provide application benefits in food service, retail, or consumer-based applications where status tracking, monitoring, and managing an item (to which the tag 240 is affixed) is needed.

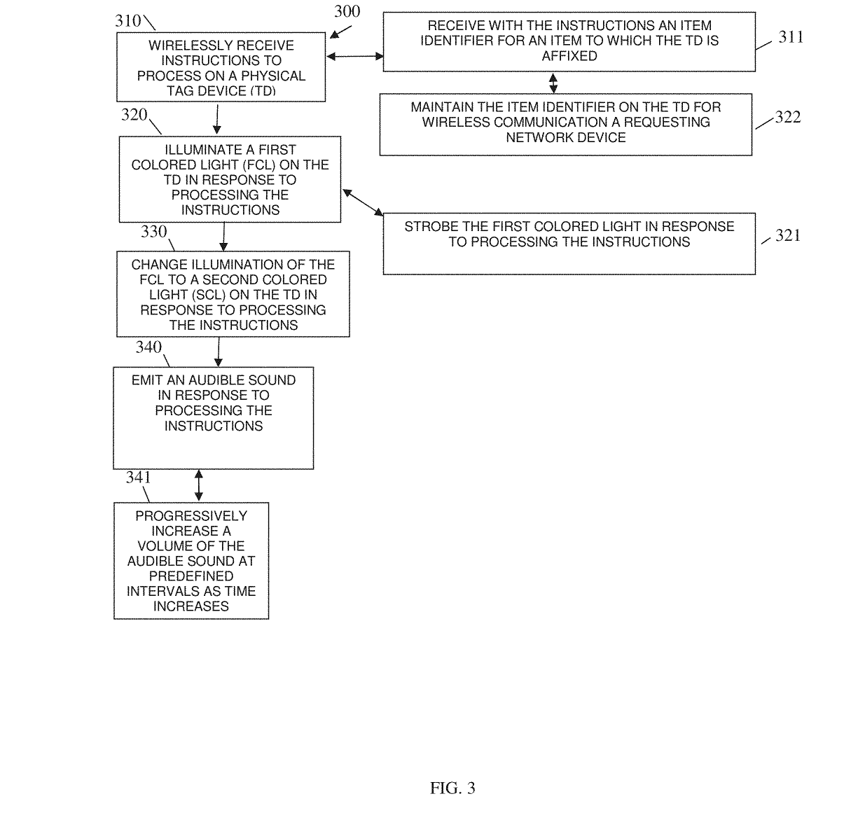

FIG. 3 is a diagram of a method 300 for managing and tracking a band/tag with integrated status and tracking capabilities. The software module(s) that implements the method 300 is referred to as a “tag interface.” The tag interface is implemented as executable instructions programmed and residing within memory and/or a non-transitory computer-readable (processor-readable) storage medium and executed by one or more hardware processors of a hardware processing device. The processors of the device that executes the tag interface are specifically configured and programmed to process the tag interface. The tag interface is operational over a wireless network.

In an embodiment, the device that executes the tag interface is the tag 114.

In an embodiment, the device that executes the tag interface is the tag 240.

In an embodiment, the tag 114 that executes the tag interface is affixed to a band 110A, 111 or 112.

In an embodiment, the tag interface implements, inter alia, the processing discussed above with reference to the FIG. 2.

At 310, the tag interface wirelessly receives instructions to process on the physical tag device (tag 114 and/or tag 240).

According to an embodiment, at 311, the tag interface receives with the instructions an item identifier for an item to which the physical tag device is affixed.

In an embodiment of 311 and at 312, the tag interface maintains the item identifier on the physical tag device for wireless communication to a requesting network device.

At 320, the tag interface illuminates a first colored light on the physical tag device in response to processing the instructions. That is, an initial color for illumination is provided in the received instructions. In another case, the tag interface is configured to by default illuminate the first colored light when the instructions include no identification of the initial color.

In an embodiment, at 321, the tag interface strobes the first colored light in response to the processing instructions. Thus, effects that illustrate different statuses for the item can be achieved through effects of the first colored light. For instance, suppose that a time count down (as discussed at length above) is under 10 minutes before expiring (reaching zero), the tag interface pursuant to the programming instructions may begin to slowly strobe the first colored light when the countdown reaches under 5 minutes the rate of the strobe can be increased and so on, such that the status associated with the first colored light can be altered to indicate that the status is going to change in a configured amount of time.

At 330, the tag interface changes illumination of the first colored light to a second colored light on the physical tag device in response to processing the instructions. This is a visual indication emitted from the physical tag device that a previous status for the item to which the physical tag device is affixed has changed to a new current status represented by the second colored light.

According to an embodiment, at 340, the tag interface emits an audible sound in response to processing the instructions. The sound can be used for a variety of purposes to indicate that the status for the item changed through the switching to the second colored light and provide an audible alarm in addition to the visual indication (change to the second colored light). The sound can also be used for locating the item (locating tracking services).

In an embodiment of 340 and at 341, the tag interface progressively increases a volume of the audible sound at predefined intervals as time increases. So, similar to the strobing effects of the emitted colored light, audible effects can be used. For example, increasing the volume at intervals of time as time increases may permit someone to locate (audibly) the item to which the physical tag device is affixed more easily.

It should be appreciated that where software is described in a particular form (such as a component or module) this is merely to aid understanding and is not intended to limit how software that implements those functions may be architected or structured. For example, modules are illustrated as separate modules, but may be implemented as homogenous code, as individual components, some, but not all of these modules may be combined, or the functions may be implemented in software structured in any other convenient manner.

Furthermore, although the software modules are illustrated as executing on one piece of hardware, the software may be distributed over multiple processors or in any other convenient manner.

The above description is illustrative, and not restrictive. Many other embodiments will be apparent to those of skill in the art upon reviewing the above description. The scope of embodiments should therefore be determined with reference to the appended claims, along with the full scope of equivalents to which such claims are entitled.

In the foregoing description of the embodiments, various features are grouped together in a single embodiment for the purpose of streamlining the disclosure. This method of disclosure is not to be interpreted as reflecting that the claimed embodiments have more features than are expressly recited in each claim. Rather, as the following claims reflect, inventive subject matter lies in less than all features of a single disclosed embodiment. Thus the following claims are hereby incorporated into the Description of the Embodiments, with each claim standing on its own as a separate exemplary embodiment.

1. A physical tag device, comprising:
a hardware-processor;
a controller configured to i) execute on the hardware processor, ii) wirelessly receive instructions for selectively activating illumination of one of a plurality of colored lights, and iii) illuminating a different one of the plurality of colored lights during processing of the instructions; and
an affixing mechanism configured to affix the physical tag to an item

2. The physical tag of claim 1 further comprising, a timer clock coupled to the controller, the timer clock configured to be set through the instructions to an initial countdown time and progressively counts down from the countdown time to zero and when reaching zero, the controller configured to process iii).

3. The physical tag of claim 1 further comprising, wirelessly circuitry configured for wirelessly receiving the instructions over a wireless network connection from a network-connected device.

4. The physical tag of claim 1 further comprising, a speaker coupled to the controller, the speaker configured to emit an audible sound or tone out the speaker during processing of the instructions.

5. The physical tag of claim 1, wherein the controller is further configured to iv) wirelessly communicate a unique identifier for the physical tag to a network-connected device and wireless communicate a status of the physical tag to the network-connected device.

6. The physical tag of claim 5, wherein controller is further configured to iv) wirelessly receive an item identifier and an item classification from the network-connected device, v) maintain the item identifier and the item classification, and vi) wirelessly communicate the item identifier and the item classification to the network-connected device when requested by the network-connected device.

7. A band, comprising:
a stretchable colored band; and
a void area surrounded by the stretchable colored band;
wherein the stretchable colored band configured to stretchable expand to cover a top opening of a container and contract to affix along a periphery of sides of the top opening to remain attached to the container.

8. The band of claim 7, wherein the stretchable colored band is made of materials that is resistant to heat and cold.

9. The band of claim 7, where the stretchable colored band is made of materials that can be washed or cleaned for reuse.

10. The band of claim 7 further comprising, a timer clock integrated into one portion of the stretchable colored band.

11. The band of claim 7 further comprising, a timer clock configured to be attachable to and removable from one portion of the stretchable color band.

12. The band of claim 7, wherein the void area is configured to increase in surface area when the stretchable colored band is stretched to cover the top opening of the container.

13. The band of claim 7, wherein the void area is initially configured to have a surface area that is less than a top opening surface area for the top opening of the container.

14. A method, comprising:
wirelessly receiving, by a physical tag device, instructions to processing on the physical tag device;
illuminating, by the physical tag device, a first colored light on the physical tag device in response to processing the instructions; and
changing, by the physical tag device, illumination of the first colored light to a second colored light on the physical tag device in response to processing the instructions.

15. The method of claim 14 further comprising, emitting an audible sound, by the physical tag device, in response to processing the instructions.

14. The method of claim 15, wherein emitting further includes progressively increasing a volume of audible sound at predefined intervals as time increases.

15. The method of claim 12, wherein wireless receiving further includes receiving with the instructions an item identifier for an item to which the physical tag device is affixed.

16. The method of claim 15, wherein receiving further includes maintaining the item identifier on the physical tag device for wireless communication to a requesting network device.

17. The method of claim 12, wherein illuminating further includes strobing the first colored in response to processing the instructions.

18. A system, comprising:
a network-connected device; and
a physical tag device affixed to an item;
wherein the networked connected device is configured to: i) wirelessly program the physical tag device with instructions and an item identifier for the item, and wherein the physical tag device is configured to: i) processing the instructions on the physical tag device, ii) illuminate an first colored light from the physical tag device in response to processing the instructions, and iii) change to a second colored light during the processing of the instructions.

19. The system of claim 18, wherein the networked-connected device is one of: a server and a user-operated device.

20. The system of claim 19, the networked-connected device is the server and the server configured to act as an intermediary for the user-operated device in programming the physical tag device with the instructions and the item identifier for the item.
